(19) United States
(12) Patent Application Publication
(10) Pub. No.: US 2006/0113177 A1
(43) Pub. Date: Jun. 1, 2006

(54) Switch

(75) Inventor: Li Xin, Tokyo (JP)

Correspondence Address: FOLEY AND LARDNER LLP;SUITE 500, 3000 K STREET NW, WASHINGTON, DC, 20007, US

(73) Assignee: SMK Corporation

(21) Appl. No.: 10/540,855

(22) PCT Filed: Feb. 25, 2003
(86) PCT No.: PCT/JP03/02050

§ 371 Date: Jun. 27, 2005

(51) Int. Cl. H01H 19/00

(52) U.S. Cl. 200/558

(57) ABSTRACT

The switch of this invention is comprised of a case, a first fixing terminal formed with a contact section exposed at the bottom surface of the case at one end with the other end being outside of the case, a second fixing terminal formed with a contact section exposed at a side surface of a case at one end and with the remaining end being provided outside of the case, a contact piece provided within the case, formed with a fixed contact section always in contact with the first fixing terminal at one end and a moveable contact section capable of contact with the other second fixing terminal at the other end, and with a coil spring section having resilience in a coil winding direction and compression direction at a central section, and an operation body with one end positioned within the case so as to form a pressing section capable of pressing the contact piece in a direction of compression and another end being positioned outside of the case so as to form an operation section pressed from outside.

### BACKGROUND OF THE INVENTION

1. Field of the Invention

This invention relates to a push-type switch used in electronic equipment, and specifically relates to a switch turning on and off as a result of ends of a built-in coil spring connecting and disconnecting with contact terminals.

2. Description of Related Art

For example, a “switch” as disclosed in Japanese Laid-open Patent Publication No. Hei. 7-93074 (related art 1) is provided where a conductive spring is built-into a casing, so that the switch is made to go on and off as a result of contact pieces freely making and breaking contact with connection terminals provided on the inside surface of the box. The “switch” of related art 1 is comprised of a substantially box-shaped case where fixing elements are implanted in a planar manner in an inner bottom surface, a coiled spring contacting piece having a moving end having a springy conductive member curved in the shape of a U with a contact point at an end thereof curved substantially in a semi-circle shape and a fixing end having a contact point at an end thereof while being substantially straight, an operating body constituted by a substantially cylindrical molded member having an inverted c-shaped groove at one end, sliding in a longitudinal direction so as the inverted c-shaped groove traverses the moving end of the contact piece, and a cover supporting the operating body coupled to the case in a slidable manner and sandwiching the coil of the contact piece together with the case.

In related art 1, as shown in FIG. 15, fixing terminals 112 and 113 are provided at the bottom surface within the case 111. A contact piece 114 made of a conductive member having springiness is provided within the case 111. The contact piece 114 is provided such that one end of a coiled spring section 114e is curved in a U-shape, and is formed with a moveable end 114b having a contact point 114c bent in a substantially semi-circular shape at one end, and the other end is in a rectilinear shape forming a fixing end 114a having a contact point 114d making contact with the fixing terminal at the front end.

A contact piece 114 forming a fixing end 114a having a contact point 114d making contact with the terminal 112 is provided.

An operating body 115 is substantially cylindrical and has an inverted c-shaped groove 115a at one end. This groove 115a spans the movable end 114c of the contact piece 114 and is made to slide in a longitudinal direction so that the contact point 114c and the fixing terminal 113 connect and disconnect.

The cover 116 is a lid containing the contact piece 114 within the upper part of the case 111. The cover 116 has a hole 116a supporting the operating body 115 in a manner capable of sliding, links with the case 111, and has a projection 116b sandwiching the coil section 114e of the contact piece 114 together with a u-shaped depression 111a of the case 111.

In the related art 1 formed in this manner, the moveable end 114b is caused to move downwards as a result of the operating body 115 being pressed downwards so as to slide in a manner resisting spring force of the contact piece 114. At this time, the moveable end 114b is made to move according to the spring force of a coil spring and a curve of the moveable end 114b as a result of a spring section 114e moving in a winding direction of the coiled spring taking the contact point 114d making contact with the contact terminal 112. The contact point 114c moves in a horizontal direction in FIG. 15 as a result of the moveable end 114b moving in a downward direction, and is moved to the position of the fixing terminal 113 so as to make contact with the fixing terminal 113, so that the fixing terminal 112 and the fixing terminal 113 enter a conducting state.

Further, when the thrust of the operating body 115 ends, the contact piece 114 returns to its original position due to its own spring force, the contact point 114c is separated from the fixing terminal 113, and the fixing terminal 112 and the fixing terminal 113 enter an insulating state.

However, with the switch of related art 1, the operating body 115 is slid downwards so that the fixing end 114a and the moveable end 114b of the contact piece 114 make contact with the fixing terminal 112 and fixing terminal 113. However, the operating force acting against movement in a downward direction and the contact force necessary in contact between the contact terminal 113 and the fixed terminal 114a and contact between the contact terminal 113 and the moveable end 114b is made by the resilient force due to torsion in the winding direction of the spring section 114e of the contact piece 114.

Resilient force generated by torsion in the winding direction of the coil spring changes according to the amount of torsion. It is therefore difficult to maintain a set value for contact pressure between the contact piece and the fixing terminal.

In particular, with push switches for detecting position used in various electronic equipment for detecting a position of a CD tray etc. of a CD player or computer etc., the operation force used in pressing the push switch is 0 and contact pressure between the contact piece and the fixing terminal is ideally a set value. In the related art example, when the operation force pressing the push switch is made small, contact pressure between the contact piece and the fixing terminals becomes small and there is therefore the problem that the operation force has to be large to implement the set contact pressure. When operation force is made small, the contact pressure is also made small, and contact pressure at a contact start position for the contact piece and the fixing terminal and contact pressure at a time when the contact piece further moves after contact become different. Contact resistance at the contact start position therefore becomes large, errors occur at positions judged to be conducting, and detected position precision therefore becomes poor.

The operation direction of the contact piece due to the operating body deforms the contact piece in the winding direction of the coil spring. This therefore made it difficult to make the operation direction of the switch short.

In order to resolve the aforementioned problems, this invention is advantageous in providing a switch where change in contact pressure due to the position of a contact piece is small.

### SUMMARY OF THE INVENTION

A switch characterized by: a case forming a case shape; a pair of fixing terminals with contact sections exposed at an inner surface of a case formed at one end and with remaining ends being positioned outside of the case; a contact piece, provided within the case, with a fixing contact section always in contact with a fixing terminal formed at one end, a moveable contact section capable of making contact with another fixing terminal provided at the other end, and a central part with a coil spring having resilience in a coil winding direction and compression direction; and an operation body with one end positioned within the case so as to form a pressing section capable of pressing the contact piece in a compression direction and with another end positioned outside of the case so as to form an operation section pressed from outside.

The contact piece provided within the case is such that a fixing contact section constituting one end is always connected to a fixed terminal and a moveable contact section constituting another end is pressed against a wall within the case due to resilient force in a winding direction of the coil spring at the inner wall of the case so as to make contact so as to be positioned in a position capable of making contact with the other fixed terminal but not in contact in a usual state.

In this state, when the operation section of the operation body is pressed down, the operation body moves in a direction to within the case. In doing so, the pressing section of the operation body presses and compresses the coil spring of the contact piece in a direction of compression.

The contact piece moves while making contact with an inside wall of the case due to the resilient force in the twisting direction of the coil spring, and makes contact with the other fixing terminal.

The switch is then put into an electrically conducting state by short-circuiting the fixed terminals as a result of the fixing contact section and the moveable contact section of the contact piece making contact with the respective fixing terminals.

When pressing of the operation part of the operation body is released, the contact piece is elongated due to resilient force in a compression direction of the coil spring and an initial position is returned to. The operation body therefore moves back to the original position as a result of resilient force in the compression direction of the coil spring.

### BRIEF DESCRIPTION OF THE DRAWINGS

FIG. 1 is a plan view illustrating a first embodiment of the invention.

FIG. 2 is a front view illustrating the same.

FIG. 3 is a right side view illustrating the same.

FIG. 4 is a cross-section illustration along line A-A of FIG. 1,

FIG. 5 is a cross-section illustration along line B-B of FIG. 1.

FIG. 6 is a perspective illustration showing the first embodiment with a part removed.

FIG. 7 is a view illustrating the same.

FIG. 8 is a perspective view illustrating parts of the first embodiment.

FIG. 9 is a perspective plan view illustrating a second embodiment of this invention.

FIG. 10 is a front view illustrating the same.

FIG. 11 is a plan view illustrating the same.

FIG. 12 is a right side view illustrating the same.

FIG. 13 is a cross-sectional illustration along line D-D of FIG. 11.

FIG. 14 is a cross-sectional illustration along line E-E of FIG. 10.

FIG. 15 is a view illustrating the related art.

### DESCRIPTION OF THE EMBODIMENTS

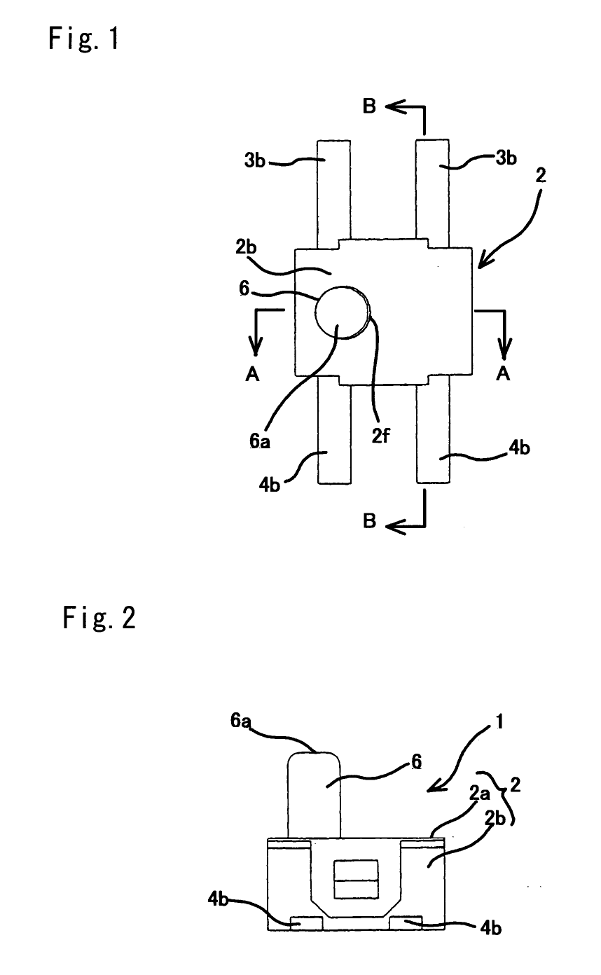

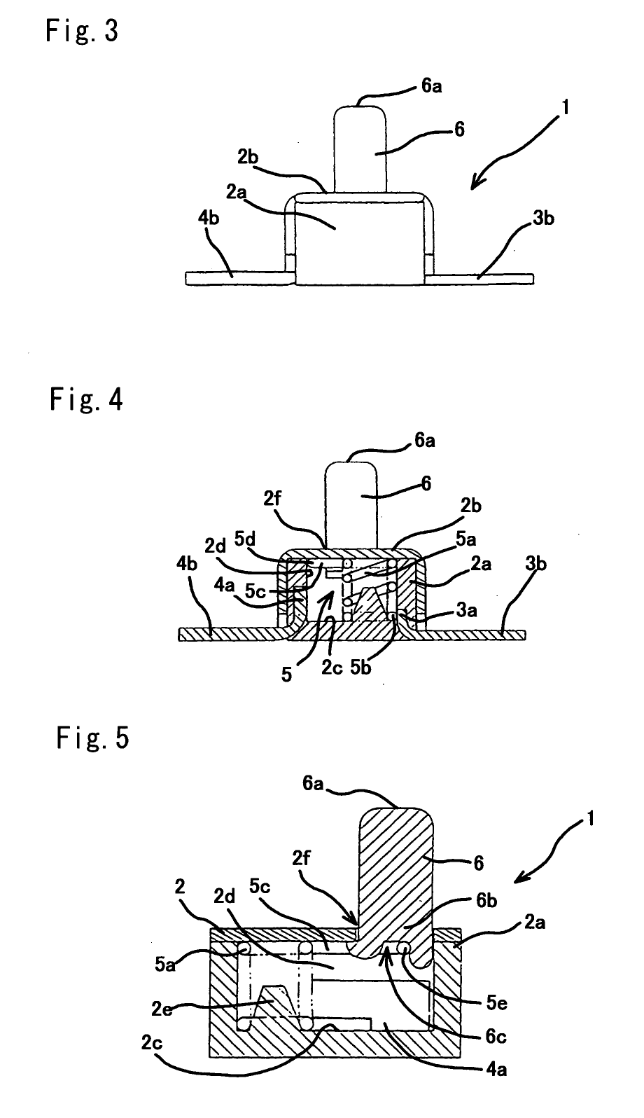

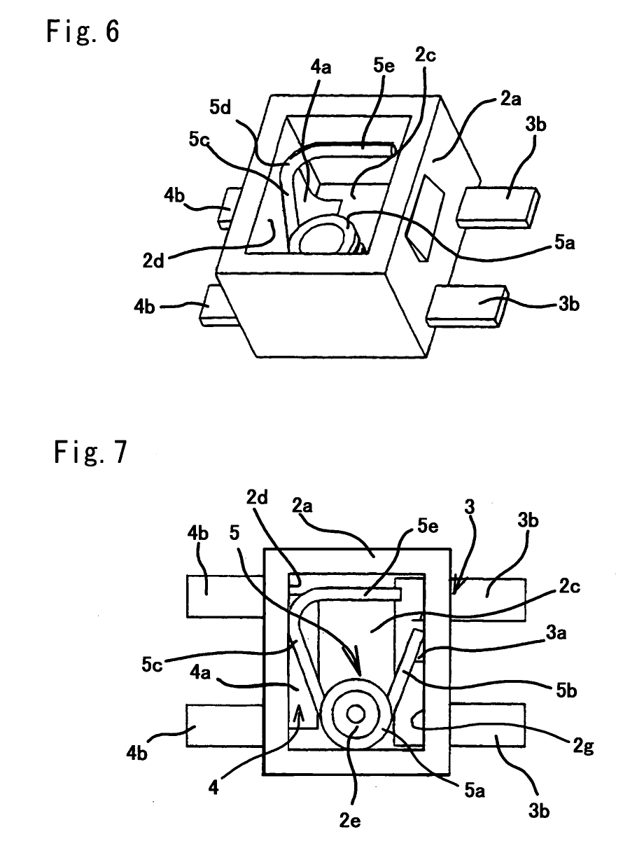

Numeral 1 is a switch of a first embodiment of the invention. The switch 1 is a push-switch for position detection used for various electronic equipment and may be used, for example, for detecting moveable positions of positions of CD trays used as moveable members in CD drives etc. for use in audio equipment or computers etc. As shown in FIG. 1 to FIG. 6, the switch 1 is comprised of a case 2 consisting of a case body 2a formed of a substantially cylindrical shape with one end open and a cover 2b covering the open end of the case body 2a, a first fixing terminal 3 provided so that a contact section 3a is exposed at the bottom surface 2c of the case 2 within the case 2, a second fixing terminal 4 provided on a side surface of the case 2 within the case 2 so that a contact point 4a is exposed, a contact piece 5 with a central section making contact with a side surface 2d within a case 2 as a result of both ends of a coil spring shape and an operation body 6 enabling the contact piece 5 to be pressed from outside of the case 2.

The case 2 is such that the case body 2a is formed from polyphthalimide resin, a projection 2e for positioning the contact piece 5 is formed facing towards the upper surface at the end of the bottom surface 2a, and the cover 2b is formed of a metal plate. An opening 2f is provided at the cover 2b so that an operation body 6 can be inserted through at a location positioned at a side of an end part of the case body 2a different to the upper end of the projection 2e while the cover 2b covers the opening of the case body 2a.

A plane-shaped contact section 3a is formed at one end of the first fixing terminal 3, and a connection terminal 3b is formed at the other end.

A plane-shaped contact point 4a is formed at one end of the second fixing terminal 4, and a connection terminal 4b is formed at the other end.

The first fixing terminal 3 and second fixing terminal 4 are formed integrally by insertion molding together with the case body 2a in such a manner that the connection terminal 3b and the connection terminal 4b project to outside of the case body 2a and the contact section 3a is exposed by the bottom surface 2c within the case body 2a, and the contact point 4a is exposed at the side surface 2d within the case body 2a.

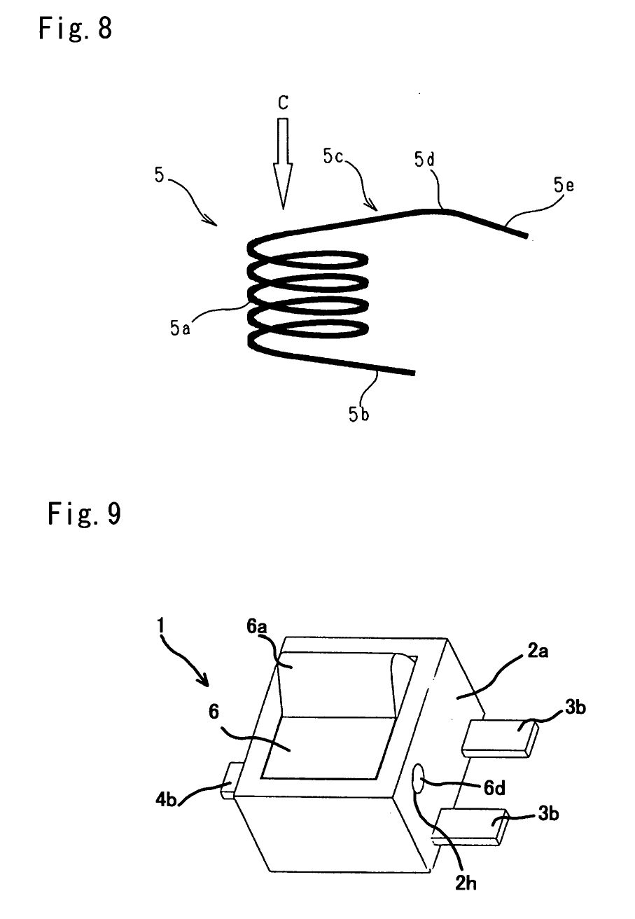

A contact piece 5 is comprised of a conductive member with a coil spring section 5a presenting a coil spring shape being formed at a central part thereof. The coil spring section 5a has resilience in a direction of winding of the coil, as shown in FIG. 8, and has resilience in a direction of compression as shown by arrow C in FIG. 8. A fixed contact point 5b is formed at an end of the contact piece 5 extending from the coil spring section 5a. The fixed contact point 5b is provided by forming one end of the coil spring section 5a in a rectilinear manner. A movable contact section 5c is then formed at the other end of the contact piece 5. A curved section 5d is provided at the end of the movable contact section 5c so as to be curved in an L-shape, with a tip rectilinear section 5a being formed from the curved section 5d.

The operation body 6 is comprised of a cylindrical body capable of being inserted into a hole 2f formed at the cover 2b with one end positioned outside of the case 2 forming a pressing section 6a when inserted in the cover 2b and another end positioned within the case 2 forming an operation section 6b. The pressing section 6a constitutes a target of position detection, and is a member pressed by, for example, a CD tray etc. The operation section 6b is formed with a c-shaped groove 6c at its tip. The operation body 6 is provided so that the tip rectilinear section 5e of the movable contact section 5c inserts into the inverse c-shaped groove 6c and is inserted in the cover 2b so that the operation section 6b is positioned within the case 2.

As shown in the drawings, the contact piece 5 is inserted into the case body 2a in a position where the fixed contact point 5b on at the side of the bottom surface 2c positioned in such a manner that a projection 2e projecting from within the case 2 is inserted into a hollow of the coil spring section 5a so that the fixed contact point 5b and the movable contact section 5c are compressed in a winding direction of the coil spring section 5a. The contact piece 5 is positioned in such a manner that the fixed contact point 5b makes contact with the contact section 3a of the first fixing terminal 3 provided at the bottom surface 2c within the case 2 and so that the movable contact section 5c is positioned at the upper side of the contact point 4a of the second fixing terminal 4 provided at the side surface 2d within the case 2. Further, the tip rectilinear section 5e of the movable contact section 5c is inserted into the inverse c-shaped groove 6c with the operation body 6 inserted through a hole 2f of the cover 2b. In this state, the cover 2b is fixed in such a manner that the open side of the case body 2a is closed over. Because the cover 2b is fitted to the case body 2a, the fixed contact point 5b is compressed in a direction of compression C between the operation body 6 and the bottom surface 2c and a contact state is therefore maintained due to the resilience of the coil spring section 5a in the direction of compression C. The movable contact section 5c is also provided positioned at the upper side of the contact point 4a provided at the side surface 2d so as to be pressed in a state of contact with the side surface 2d by the resilient force of the winding direction of the coil spring section 5a.

The following is a description of the operation of a first embodiment.

The switch 1 presses against a pressing section 6a of the operation body 6 in a state fitted at a prescribed position of the circuit substrate etc.

In doing so, the operation body 6 slides within the hole 2f of the cover 2b. When the operation body 6 slides, the tip rectilinear section 5e of the movable contact section 5c is inserted into the groove 6c of the operation body 6. The coil spring section 5a of the contact piece 5 therefore moves in a direction so as to be compressed in the direction of arrow C and the point of operation to the contact piece 5 becomes the tip rectilinear section 5e away from the coil spring section 5a. The coil spring section 5a therefore buckles. The curved section 5d of the movable contact section 5c moves while making contact with the side surface 2d within the case body 2a, makes contact with the contact point 4a of the second fixing terminal 4, and a state is attained where the contact piece 5 puts the first fixing terminal 3 and the second fixing terminal 4 in an electrically conducting state. At this time, the contact pressure between the contact point 4a of the fixing terminal 4 and the curved section 5d of the movable contact section 5c depends on the resilient force of the winding direction of the coil spring section 5a. Change in the contact pressure due to movement resulting from pressing of the operation body 6 therefore becomes substantially zero.

When pressing of the pressing section 6a is released, the operation body 6 returns to the original position due to the resilient force of the spring section 5a in the direction of arrow C and the curved section 5d of the movable contact section 5c also moves in an upward direction as shown in the drawings so that contact with the contact point 4a of the second fixing terminal 4 is also released.

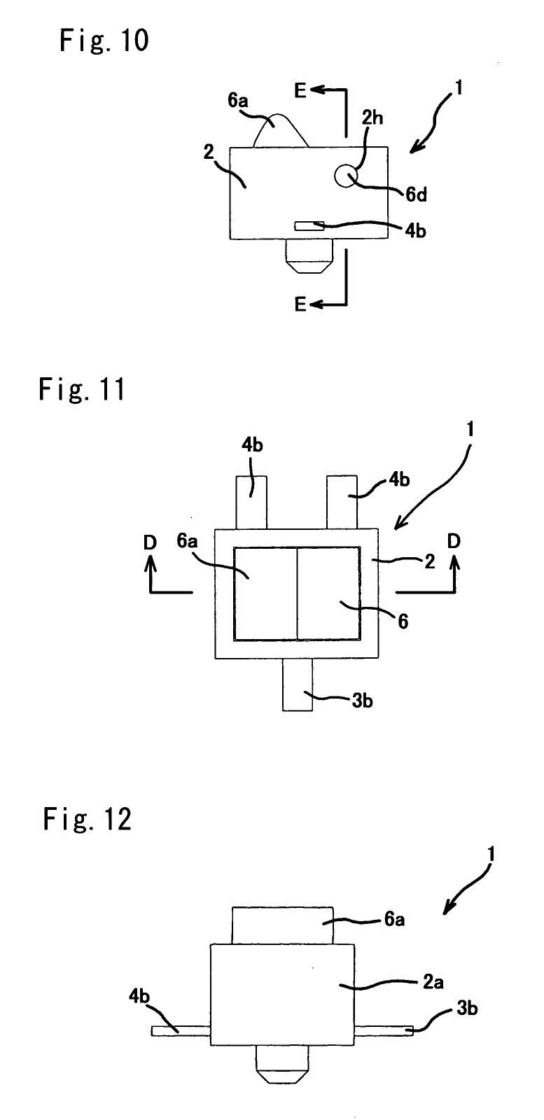

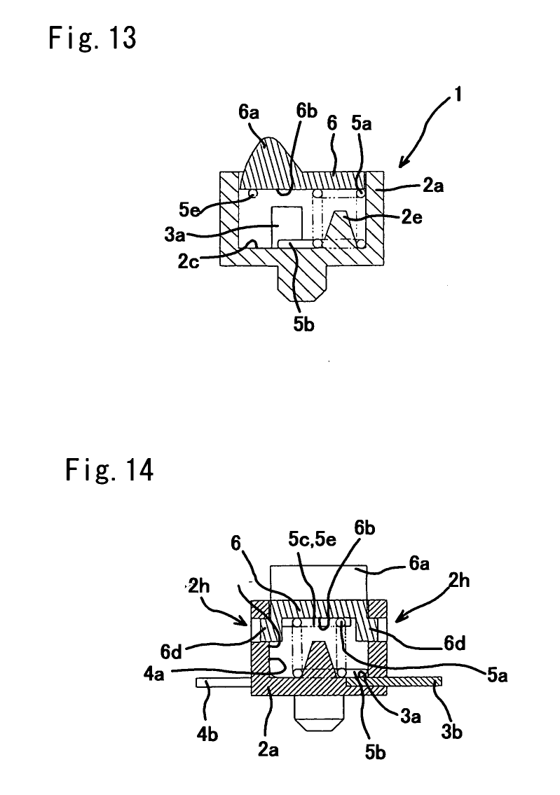

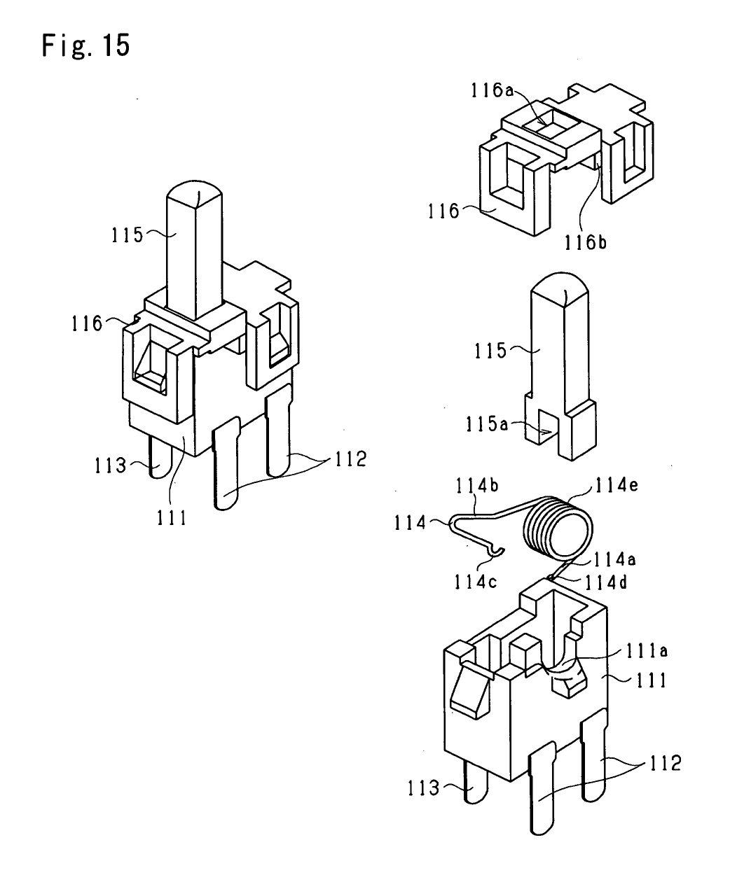

The switch 1 of the first embodiment is such that the operation direction is the winding direction of the coil spring section 5a. However, in the following, a description is given based on FIG. 9 to FIG. 14 of a second embodiment of a switch 1 capable of operation at right-angles to the direction of winding of the coil spring section 5a.

With the switch 1 of the second embodiment, a cover 2b is not provided but rather the operation body 6 doubles as the cover 2b.

The operation body 6 is comprised of a plate-shaped body substantially the same shape as the opening of the case body 2a and forms the pressing section 6a constituting a mountain-shaped projection having a gradual incline at the upper surface end of the operation body 6. A central projection 6d projects centred about a centre of swing where swinging of the pressing section 6a is possible at both sides on the opposite side to the pressing section 6a of the operation body 6. The coil spring section 5a and the movable contact section 5c come into contact at the time of fitting of the case body 2a at the surface opposite to the pressing section 6a of the operation body 6, with this opposing surface forming the operation section 6b.

Further, the case body 2a latching the operation body 6 is formed in a substantially boxed shape with one end open, as with the first embodiment. Similarly, as with the first embodiment, the first fixing terminal 3 is also formed provided with a contact section 3a and a connection terminal 3b and the second fixing terminal 4 is also formed provided with a contact section 4a and connection terminal 4b. As with the first embodiment, the first fixing terminal 3 and second fixing terminal 4 are formed integrally by insertion molding together with the case body 2a in such a manner that the connection terminal 3b and the connection terminal 4b project to outside of the case body 2a and the contact section 3a is exposed by the bottom surface 2c within the case body 2a, and the contact point 4a is exposed at the side surface 2d within the case body 2a.

As with the first embodiment, the case body 2a is integrally molded as with the first embodiment, but a point of difference with the first embodiment is that fitting holes 2h through which it is possible to insert central projections 6d of the operation body 6 are formed at the upper part of both side surfaces 2d, 2g on the sides where the projection 2e projects at the bottom surface 2C. Other than the providing of the fitting holes 2h, the case body 2a is the same as for the first embodiment.

Further, as with the first embodiment, the contact point 4a is also formed provided with the coil spring section 5a, fixed contact point 5b, movable contact section 5c, curved section 5d, and tip rectilinear section 5e.

The switch 1 of the second embodiment is such that the central projection 6d of the operation body 6 is inserted into the fitting hole 2h of the case body 2a with the contact piece 5 provided within the case body 2a as with the first embodiment, and the operation body 6 is fitted to the case body 2a in a freely swinging manner. In this state, the contact piece 5 is in a stable state where there is no compression in the direction of the arrow C is provided in such a manner as to be in a state of being deformed in the direction of winding of the coil spring section 5a in the case body 2a. The curved section 5d provided at the movable contact section 5c of the contact piece 5 is in a state of being pressed at the side surface 2d of the case body 2a. The operation body 6 is mounted on the coil spring section 5a and movable contact section 5c of the contact piece 5 so that the pressing section 6a projects at the upper part of the case body 2a.

When the pressing section 6a of the operation body 6 is pressed, the switch 1 of the second embodiment formed in this manner is such that the operation body 6 swings to the side of the bottom surface 2c of the case body 2a centred around the central projection 6d. In doing so, as in the first embodiment, when the movable contact section 5c of the contact piece 5 is moved to the side of the bottom surface 2c along the side surface 2d within the case body 2a, the coil spring section 5a is compressed to the side of the bottom surface 2c while being slightly buckled. The curved section 5d of the movable contact section 5c makes contact with the contact point 4a of the second fixing terminal 4 provided at the side surface 2d of the case body 2a, and the contact piece 5 puts the first fixing terminal 3 and the second fixing terminal 4 into an electrically conducting state.

When pressing of the pressing section 6a is released, the operation body 6 returns to the original position due to the resilient force of the spring section 5a in the direction of arrow C and the curved section 5d of the movable contact section 5c also moves in an upward direction as shown in the drawings so that contact with the contact point 4a of the second fixing terminal 4 is also released.

In the second embodiment, the operation body 6 is provided in a freely swinging manner so that the operation section 6b compresses and moves the coil spring section 5a and the movable contact section 5c. The operation of the switch 1 may therefore be a pressing force in the direction of the bottom surface 2c from the top of the switch 1, i.e. pressing force in the compression direction of the coil spring section 5a or may be pressing force in a direction parallel with the upper surface of the switch 1, i.e. in a direction pressing the inclined surface side of the pressing section 6a of the operation body 6. In the case of operation by the pressing force in a parallel direction at the upper surface of the switch 1, part of the pressing force pressing the inclined surface of the pressing section 6a is converted to swinging force as a result of causing the operation body 6 to swing at the side of the bottom surface 2c and becomes pressing force compressing the coil spring section 5a in the pressing direction.

In the second embodiment, the operation body 6 is fitted without compressing the contact piece 5 in the direction of the bottom surface 2c of the case body 2a. However, during fitting of the operation body 6 to the case body 2a, it is also possible to provide a latching recess and latching protrusion restricting swinging towards the upper part of the case body 2a on the side of the operation section 6b at the upper part of the side of the operation body 6 on the side of the operation section 6b and the case body 2a so that the operation body 6 is fitted to the case body 2a in a state where the coil spring section 5a of the contact piece 5 is compressed in the direction of the bottom surface 2c.

According to the present invention, as a result of forming the switch in the manner described above, there is substantially no deformation in the direction of winding of the coil spring section at the time of operation and the contact pressure when the contact piece makes contact with the fixed terminals is substantially fixed regardless of the extent of change in the movement of the operation body. As a result, the occurrence of a difference in a contact pressure at a contact start position where a contact piece puts a fixed terminal into a conducting state and a contact pressure for a time where the contact piece is further moved after contact that in turn causes errors in a position determining a conducting state does not occur, and precision of position detection can be improved.

Further, operation is possible without the contact piece being changed in the radial direction of the coil. The contact piece can therefore be installed in such a manner that the radial direction of the coil for the coil spring section and the switching operation direction of the connection piece are different, so that the length of the switching operation direction can be made small.

What is claimed is:

1. A switch characterized by:
a case forming a case shape;
a pair of fixing terminals with contact sections exposed at an inner surface of a case formed at one end and with remaining ends being positioned outside of the case;
a contact piece, provided within the case, with a fixed contact section always in contact with the fixing terminal formed at one end, and a moveable contact section capable of making contact with the other fixing terminal provided at the other end, and a central part with a coil spring having resilience in a winding direction of a coil and compression direction; and
an operation body with one end positioned within the case so as to form a pressing section capable of pressing the contact piece in a compression direction and an operation section with another end positioned outside of the case so as to form an operation section pressed from outside.
